(19) United States
(12) Patent Application Publication
(10) Pub. No.: US 2013/0136874 A1
(43) Pub. Date: May 30, 2013

(54) OPTICAL ASSEMBLIES INCLUDING STRESS-RELIEVING OPTICAL ADHESIVES AND METHODS OF MAKING SAME

(71) Applicants: Jianhui Xia, Woodbury, MN (US); Sunil K. Pillalamarri, Rosemount, MN (US); Stanley C. Busman, St. Paul, MN (US); Albert I. Everaerts, Oakdale, MN (US)

(72) Inventors: Jianhui Xia, Woodbury, MN (US); Sunil K. Pillalamarri, Rosemount, MN (US); Stanley C. Busman, St. Paul, MN (US); Albert I. Everaerts, Oakdale, MN (US)

(73) Assignee: 3M INNOVATIVE PROPERTIES COMPANY, ST. PAUL, MN (US)

(21) Appl. No.: 13/813,183

(22) PCT Filed: Aug. 15, 2011
(86) PCT No.: PCT/US11/47749

§ 371 Date: Jan. 30, 2013

Related U.S. Application Data
(60) Provisional application No. 61/374,785, filed on Aug. 18, 2010.

(51) Int. Cl. C09J 4/00; C09J 7/02; G02F 1/1333

(52) U.S. Cl. CPC C09J 4/00; G02F 1/1333; C09J 7/0217
USPC 428/1.5; 428/500; 428/355 AC; 156/99

(57) ABSTRACT

An optical assembly is provided that includes a display panel, a substantially transparent substrate and an adhesive composition. The adhesive composition includes the reaction product of a miscible blend that includes one or more (meth)acrylate monomer, one or more multifunctional (meth)acrylate oligomer and one or more free-radical generating photoinitiator. The one or more multifunctional (meth)acrylic oligomer includes an acrylic oligomer derived from (meth)acrylate monomers that is not substantially bonded to the adhesive composition after it has been cured by exposure to actinic radiation. Also provide is a method of making the optical assembly and a tape that includes a backing and the provided adhesive composition that has been cured.

### FIELD

The present disclosure relates to optical assemblies that include optical adhesives.

### BACKGROUND

Optically clear adhesives (OCAs) are finding wide applications in optical displays. In display applications, optical bonding may be used to adhere together optical elements such as display panels, glass plates, touch panels, diffusers, rigid compensators, heaters, and flexible films such as polarizers and retarders. Optically clear adhesives are often used for bonding in touch displays, for example, capacitive touch displays. Not only do optically clear adhesives provide mechanical bonding of the substrates but they can also greatly increase the optical quality of the display by eliminating air gaps that can reduce brightness and contrast. The optical performance of a display can be improved by minimizing the number of internal reflecting surfaces, thus it may be desirable to remove or at least minimize the number of air gaps between optical elements in the display.

### SUMMARY

The development of new electronic display products, such as wireless reading devices, has increased the demands for optically clear adhesives with stress-relieving properties to bond the displays. Recently, there has been a need for soft optically clear adhesives—adhesives that have a low modulus and a high tan δ value over a wide temperature range as measured by dynamic mechanical analysis (DMA). These soft optically clear adhesives can enable better wetting of thick inks which can typically have thicknesses of, for example, 50 μm when deposited on the displays. Soft optically clear adhesives also can relieve stress that can be produced during the initial assembly of display devices.

Thus, there is a need for soft, stress-relieving optically clear adhesives for use on electronic displays. There is a need for optically clear adhesives that have good adhesion to display substrates that have good optical characteristics, and resist bubble formation—especially after exposure to periods of heat and humidity. There is also a need for liquid optically clear adhesives and adhesive sheets that can be useful for these purposes.

In one aspect, an optical assembly is provided that includes a display panel, a substantially transparent substrate, and an adhesive layer disposed between the display panel and the substantially transparent substrate, the adhesive layer comprising the reaction product of a miscible blend comprising an acrylic oligomer, a reactive diluent comprising a mixture of one or more monofunctional (meth)acrylate monomers, and a free-radical generating initiator, wherein the acrylic oligomer comprises an acrylic oligomer derived from (meth)acrylate monomers. The free-radical initiators can include a photoinitiator and the reaction product can comprise a photo-reaction product. The acrylic oligomers can comprise an acrylic polyol. The display panel can be part of an electronic device and can be a liquid crystal display, a plasma display, a light-emitting diode (LED) display, an electrowetting display, or a cathode ray display. The adhesive composition can also include plasticizers, tackifiers, fillers, or combinations thereof. The adhesive composition can be cured by exposure to energy comprising heat or actinic radiation. The heat or actinic radiation can be absorbed by the initiator or photoinitiator to initiate a reaction that produces the reaction product.

In another aspect, a method of making an optical assembly is provided that includes providing a display panel and a substantially transparent substrate, disposing miscible blend of reactive adhesive components on the display panel, contacting the substrate with the adhesive components so as to form an optically clear laminate of the display panel, adhesive components and substrate, and exposing the optical assembly to energy at least partially absorbed by the initiator at least partially absorbed by the initiator, wherein the miscible blend comprises an acrylic oligomer, a reactive diluent comprising a mixture of one or more monofunctional (meth)acrylate monomers, and a free-radical generating initiator, wherein the acrylic oligomer comprises an acrylic oligomer derived from (meth)acrylate monomers. The oligomer can comprise an acrylic polyol.

In yet another aspect, a method of making an optical assembly is provided that includes providing a display panel and a substantially transparent substrate, and laminating a provided cured adhesive between the display panel and the substantially transparent substrate. The cured adhesive can be prepared by disposing a miscible blend of reactive adhesive components between two release liners, exposing the optical assembly to energy at least partially absorbed by the initiator to fully cure the adhesive components, wherein the miscible blend comprises an acrylic oligomer, a reactive diluent comprising a mixture of one or more monofunctional (meth)acrylate monomers, and a free-radical generating initiator, and wherein the acrylic oligomer comprises an acrylic oligomer derived from (meth)acrylate monomers. The initiator can comprise a photoinitiator and the energy can comprise actinic radiation.

In yet another aspect, an adhesive article is provided that includes a backing material and a pressure-sensitive adhesive composition disposed upon the backing material, wherein the pressure-sensitive adhesive composition comprising the reaction product of a miscible blend comprising a) from about 60 parts to about 5 parts of a mixture of one or more (meth)acrylic oligomers, b) from about 40 parts to about 95 parts of a mixture of one or more monofunctional (meth)acrylate monomers, and c) from about 0.01 parts to about 1.0 part of one or more free-radical generating initiators based upon 100 parts of components a) and b), wherein the acrylic oligomer derived from (meth)acrylate monomers is not substantially crosslinked into to the cured composition. The acrylic oligomers can comprise an acrylic polyol.

In this disclosure:

“acrylic oligomer”—refers to low molecular weight polymers that have repeat units that are (meth)acrylic repeat units made from monofunctional acrylic monomers;

“ink step” refers to the height of the edge of a printed ink pattern compared to the height of the substrate upon which the ink is printed;

“(meth)acrylate” or “(meth)acrylic” refers to either the acid or derivatives of acrylic acid or methacrylic acid or a mixture thereof;

“multifunctional (meth)acrylate oligomer” refers to low molecular weight polymers that have repeat units that are (meth)acrylic repeat units made from multi-functional acrylic monomers; and

“photoinitiator” refers to a species that can absorb selected wavelengths of actinic radiation (frequently in the ultraviolet range) and can form free-radical initiating species either directly or by energy transfer to a free-radical initiating species.

The provided optical assemblies and methods of making the same adhesives provide mechanical bonding of the substrates can increase the optical quality of optical display components of the assemblies by eliminating air gaps. Additionally they can reduce brightness and contrast by minimizing the number of internal reflecting surfaces. The provided optical assemblies are useful on electronic display devices, such as hand-held electronic devices to reduce bubble formation and to give a uniform appearance to the observer.

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

FIG. 1 is a plot of tan δ vs. temperature (−40° C. to 110° C.) for an optical adhesive used in an embodiment of the provided optical assembly and a comparative adhesive.

FIG. 2 is a plot of tan δ vs. temperature (−20° C. to 100° C.) for an optical adhesive used in an embodiment of the provided optical assembly and a comparative adhesive.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Optical materials may be used to fill gaps between optical components or substrates of optical assemblies. Optical assemblies comprising a display panel bonded to an optical substrate may benefit if the gap between the two is filled with an optical material that matches or nearly matches the refractive indices of the panel and the substrate. For example, sunlight and ambient light reflection inherent between a display panel and an outer cover sheet may be reduced. Color gamut and contrast of the display panel can be improved under ambient conditions. Optical assemblies having a filled gap can also exhibit improved shock-resistance compared to the same assemblies having an air gap.

An optical assembly having a large size or area can be difficult to manufacture, especially if efficiency and stringent optical quality are desired. A gap between optical components may be filled by pouring or injecting a curable composition into the gap followed by curing the composition to bond the components together. However, these commonly used compositions have long flow-out times which contribute to inefficient manufacturing methods for large optical assemblies.

The assembly process of these optical displays can be particularly challenging if mechanical distortion sensitive components, such as LCD or OLED are involved or the substrates have significant topographic features to it, such as a printed cover lens where the ink step may be as high as 60-70 μm. When using a liquid optically clear adhesive, one has to be concerned about the curing shrinkage and resulting stress on the components, like the LCD which may become distorted causing visible optical defects. Due to the abrupt change in adhesive thickness at the ink edge, excessive shrinkage and high elasticity in the cured liquid adhesive may result in optical distortions and stress concentration near this edge, potentially causing display failure. The provided adhesive compositions can provide a unique combination of low shrinkage and low modulus to prevent this failure. Once the liquid adhesive is fully cured, the optically clear adhesive also has to be resistant to durability testing of the assembled display, requiring a good balance of adhesion, optics, and drop test tolerance. Because of the sometimes significant thickness (even on the mm scale) of the cell gap that needs to be filled, finding the right balance between these adhesive performance attributes and the curing characteristics is challenging.

The optically clear adhesive may also be used in transfer tape format instead of using the liquid form to fill the air gap between the display substrates. In this process, the liquid adhesive composition of this invention can be applied between two siliconized release liners, at least one of which is transparent to UV radiation that is useful for curing. The adhesive composition can then be cured (polymerized) by exposure to actinic radiation at a wavelength at least partially absorbed by a photoinitiator contained therein. A transfer tape that includes a pressure-sensitive adhesive can be thus formed. The formation of a transfer tape can reduce stress in the adhesive by allowing the cured adhesive to relax prior to lamination. For example, in a typical assembly process, one of the release liners of the transfer tape can be removed and the adhesive can be applied to the display assembly. Then, the second release liner can be removed and lamination to the substrate can be completed. When the substrate and the display panel are rigid adhesive bonding can be assisted with vacuum lamination equipment to assure that bubble are not formed in the adhesive or at the interfaces between the adhesive and the substrate or display panel. Finally, the assembled display components can be submitted to an autoclave step to finalize the bond and make the optical assembly free of lamination defects.

When the cured adhesive transfer tape is laminated between a printed lens and a second display substrate, prevention of optical defects can be even more challenging because the fully cured adhesive may have to conform to a sometimes large ink step (i.e., 50-70 μm) and the total adhesive thickness acceptable in the display may only be 150-250 μm. Completely wetting this large ink step during initial assembly (for example, when printed lens is laminated to the second substrate with the optically clear adhesive transfer tape of this invention) is very important, because any trapped air bubbles may become very difficult to remove in the subsequent display assembly steps. The optically clear adhesive transfer tape needs to have sufficient compliance (for example, low shear storage modulus, G′, at lamination temperature, typically 25° C., of <10⁵ Pascal (Pa) when measured at 1 Hz frequency) to enable good ink wetting, by being able to deform quickly, and to comply to the sharp edge of the ink step contour. The adhesive on the transfer tape also has to have sufficient flow to not only comply with the ink step but also wet more completely to the ink surface. The flow of the adhesive can be reflected in the high tan delta value of the material over a broad range of temperatures (i.e. tan δ>0.4 between the T_{g} of the adhesive (measured by DMA) and about 50° C. or slightly higher). The stress caused by the rapid deformation of the optically clear adhesive tape by the ink step, requires the adhesive to respond much faster than the common stress caused by a coefficient of thermal expansion mismatch, such as in polarizer attachment application where the stress can be relieved over hours instead of seconds or shorter. However, even those adhesives that can achieve this initial ink step wetting may still have too much elastic contribution from the bulk rheology and this can cause the bonded components to distort, which is not acceptable. Even if these display components are dimensionally stable, the stored elastic energy (due to the rapid deformation of the adhesive over the ink step) may find a way to relieve itself by constantly exercising stress on the adhesive, eventually causing failure. Thus, as in the case of liquid bonding of the display components, the design of a transfer tape to successfully bond the display components requires a delicate balance of adhesion, optics, drop test tolerance, as well as compliance to high ink steps, and good flow even when the ink step pushes into the adhesive layer up to as much as 30% or more of its thickness.

In one aspect, an optical assembly is provided that includes a display panel. The display panel can include any type of panel such as a liquid crystal display panel. Liquid crystal display panels are well known and typically include a liquid crystal material disposed between two substantially transparent substrates such as glass or polymer substrates. As used herein, substantially transparent refers to a substrate that is suitable for optical applications, e.g., has at least 85% transmission over the range of from 460 to 720 nm. Optical substrates can have, per millimeter thickness, a transmission of greater than about 85% at 460 nm, greater than about 90% at 530 nm, and greater than about 90% at 670 nm. Transparent electrically conductive materials that function as electrodes can be present on the inner surfaces of the substantially transparent substrates. In some cases, on the outer surfaces of the substantially transparent substrates can be polarizing films that can pass essentially only one polarization state of light. When a voltage is applied selectively across the electrodes, the liquid crystal material can reorient to modify the polarization state of light, such that an image can be created. The liquid crystal display panel can also comprise a liquid crystal material disposed between a thin film transistor array panel having a plurality of thin film transistors arranged in a matrix pattern and a common electrode panel having a common electrode.

In some other embodiments, the display panel may comprise a plasma display panel. Plasma display panels are well known and typically comprise an inert mixture of noble gases such as neon and xenon disposed in tiny cells located between two glass panels. Control circuitry charges electrodes within the panel can cause the gases to ionize and form a plasma which then can excite phosphors contained therein to emit light.

In other embodiments, the display panel may comprise a light-emitting diode (LED) display panel. Light-emitting diodes can be made using organic or inorganic electroluminescent materials and are well known to those having ordinary skill in the art. These panels are essentially a layer of an electroluminescent material disposed between two conductive glass panels. Organic electroluminescent materials include organic light emitting diodes (OLEDs) or a polymer light emitting diode (PLEDs).

In some embodiments, the display panel may comprise an electrophoretic display. Electrophoretic displays are well known and are typically used in display technology referred to as electronic paper or e-paper. Electrophoretic displays can include a liquid electrically-charged material disposed between two transparent electrode panels. Liquid charged material include nanoparticles, dyes, and charge agents suspended in a nonpolar hydrocarbon, or microcapsules filled with electrically-charged particles suspended in a hydrocarbon material. The microcapsules may also be suspended in a layer of liquid polymer. In some embodiments, the display panel can include a cathode ray tube display.

The provided optical assemblies include a substantially transparent substrate. The substantially transparent substrate can include a glass or a polymer. Useful glasses can include borosilicate, soda lime, and other glasses suitable for use in display applications as protective covers. One particular glass that may be used comprises EAGLE XG and JADE glass substrates available from Corning Inc., Corning N.Y. Useful polymers include polyester films such as polyethylene terephthalate, polycarbonate films or plates, acrylic films such as polymethylmethacrylate films, and cycloolefin polymer films such as ZEONOX and ZEONOR available from Zeon Chemicals (Louisville, Ky.). The substantially transparent substrate typically has an index of refraction close to that of display panel and/or the adhesive layer; for example, from about 1.4 and about 1.7. The substantially transparent substrate typically has a thickness of from about 0.5 mm to about 5 mm.

The provided optical assembly can be touch-sensitive. Touch-sensitive optical assemblies (touch-sensitive panels) can include capacitive sensors, resistive sensors, and projected capacitive sensors. Such sensors include transparent conductive elements on substantially transparent substrates that overlay the display. The conductive elements can be combined with electronic components that can use electrical signals to probe the conductive elements in order to determine the location of an object near or in contact with the display. Touch-sensitive optical assemblies are well known and are disclosed, for example, in U.S. Pat. Publ. Nos. 2009/0073135 (Lin et al.), 2009/0219257 (Frey et al.), and PCT Publ. No. WO 2009/154812 (Frey et al.). Positional touch-sensitive touch panels that include force sensors are also well known and are disclosed, for example, in touch screen display sensors that include force measurement include examples based on strain gauges such as is disclosed in U.S. Pat. No. 5,541,371 (Baller et al.); examples based on capacitance change between conductive traces or electrodes residing on different layers within the sensor, separated by a dielectric material or a dielectric structure comprising a material and air such as is disclosed in U.S. Pat. Nos. 7,148,882 (Kamrath et al.) and 7,538,760 (Hotelling et al.); examples based on resistance change between conductive traces residing on different layers within the sensor, separated by a piezoresistive composite material such as is disclosed in U.S. Pat. Publ. No. 2009/0237374 (Li et al.); and examples based on polarization development between conductive traces residing on different layers within the sensor, separated by a piezoelectric material such as is disclosed in U.S. Pat. Publ. No. 2009/0309616 (Klinghult et al.). Positional touch screens are also disclosed, for example, in U.S. Ser. No. 61/353,688 (Frey et al.).

For use in the provided optical assemblies, an adhesive layer needs to be suitable for optical applications. For example, the adhesive layer may have at least 85% transmission over the range of from 460 to 720 nm. The adhesive layer may have, per millimeter thickness, a transmission of greater than about 85% at 460 nm, greater than about 90% at 530 nm, and greater than about 90% at 670 nm. These transmission characteristics provide for uniform transmission of light across the visible region of the electromagnetic spectrum which is important to maintain the color point in full color displays. Additionally, the adhesive layer typically has a refractive index that matches or closely matches that of the display panel and/or the substantially transparent substrate. For example, the adhesive layer may have a refractive index of from about 1.4 to about 1.7.

The adhesive layer may have any thickness. The particular thickness employed in the optical assembly may be determined by any number of factors, for example, the design of the optical device in which the optical assembly is used may require a certain gap between the display panel and the substantially transparent substrate. The adhesive layer typically can have a thickness of from about 1 μm to about 5 mm, from about 50 μm to about 1 mm, or from about 50 μm to about 0.2 mm. The adhesive layer can be made from the reaction product of a miscible blend wherein the miscible blend has a viscosity suitable for efficient manufacturing of large optical assemblies. Miscible blends are referred herein as “liquid compositions” or “liquid optically clear adhesives” even though the adhesives are actually the reaction product of the miscible blends upon exposure of the optical assemblies to actinic radiation at a wavelength at least partially absorbed by one or more photoinitiators contained therein. A large optical assembly may have an area of from about 15 cm² to about 5 m² or from about 15 cm² to about 1 m². For example, the liquid composition may have a viscosity of from about 100 centipoise (cps) to about 40000 cps, from about 500 cps to about 10000 cps, or from about 1000 cps to about 5000 cps, wherein viscosity is measured for the composition at 25° C. If the composition is thixotropic in that it comprises a thixotropic agent, it may exceed the upper limit of viscosity. The liquid composition is amenable for use in a variety of manufacturing methods.

The provided optical assembly includes an adhesive layer disposed between the display panel and the substantially transparent substrate, the adhesive layer comprising the photo-reaction product of a miscible blend of an acrylic oligomer, a reactive diluent comprising a mixture of one or more monofunctional (meth)acrylate monomers, optionally a multifunctional acrylate or vinyl crosslinker, and a free-radical generating photoinitiator. The acrylic oligomer can be a substantially water-insoluble acrylic oligomer derived from (methacrylate monomers). In general, (meth)acrylate refers to both acrylate and methacrylate functionality.

The acrylic oligomer can be used to control the viscous to elastic balance of the cured composition of the invention and the oligomer contributes mainly to the viscous component of the rheology. In order for the acrylic oligomer to contribute to the viscous rheology component of the cured composition, the (meth)acrylic monomers used in the acrylic oligomer can be chosen in such a way that glass transition of the oligomer is below 25° C., typically below 0° C. The oligomer can made from (meth)acrylic monomers and can have a weight average molecular weight (M_{w}) of at least 1,000, typically 2,000. It should not exceed the entanglement molecular weight (Mₑ) of the composition. If the molecular weight is too low, outgassing and migration of the component can be problematic. If the molecular weight of the oligomer exceeds Mₑ, the resulting entanglements can contribute to a less desirable elastic contribution to the rheology of the adhesive composition. M_{w} can be determined by GPC. Mₑ can be determined by measuring the viscosity of the pure material as a function of molecular weight. By plotting the zero shear viscosity vs molecular weight in a log/log plot the change in slope can be define as the entanglement molecular weight. Above the Mₑ the slope will increase significantly due to the entanglement interaction. Alternatively, for a given monomer composition, Mₑ can also be determined form the rubbery plateau modulus value of the polymer in dynamic mechanical analysis provided we know the polymer density as is known by those of ordinary skill in the art. The general Ferry equation G₀=rRT/Mₑ provides a relationship between Mₑ and the modulus G₀. Typical entanglement molecular weights for (meth)acrylic polymers are on the order of 30,000-60,000.

The (meth)acrylic monomers and their ratio used in the acrylic oligomer can be chosen in such a way that the acrylic oligomers, the monofunctional (meth)acrylate monomers, the optional multifunctional acrylate or vinyl crosslinkers, and the other components of the miscible blend used to form the adhesive layer remain compatible upon curing to yield the optically clear composition of this invention. Optical clarity is defined a visible light transmission of at least 90%, and a haze of no more than 2% as described in the test methods. In general, this also means that the solubility parameters of the acrylic oligomer or oligomers and the other components in the miscible blend are relatively close or the same. Theoretical values of the solubility parameters can be calculated using different known equations and theories from the literature. These solubility parameters can be used to narrow down the choices of acrylic oligomer but experimental validation (i.e. curing and haze measurement) is needed to confirm the theoretical prediction.

In general, the acrylic oligomer can be generally free of multiple free-radically copolymerizable groups (such as pendant or terminal methacrylic, acrylic, fumaric, vinyl, allylic, or styrenic groups). Free-radically copolymerizable groups are generally absent to avoid excessive crosslinking of the cured composition. However, a limited amount of coreactivity is acceptable provided the elastic rheological component of the cured composition of the invention is not significantly increased due to this coreactivity. Thus, the acrylic oligomer may contain one free-radically reactive copolymerizable group (such as a pendant, or terminal methacrylic, acrylic, fumaric, vinyl, allylic, or styrenic group)

The acrylic oligomer can include a substantially water-insoluble acrylic oligomer derived from (meth)acrylate monomers. Substantially water-insoluble acrylic oligomer derived from (meth)acrylate monomers are well known and are typically used in urethane coatings technology. Due to their ease of use, favorable acrylic oligomers include liquid acrylic oligomer derived from (meth)acrylate monomers. The liquid acrylic oligomer derived from (meth)acrylate monomers can have a number average molecular weight (Mₙ) within the range of about 500 to about 10,000. Commercially available liquid acrylic oligomers also have a hydroxyl number of from about 20 mg KOH/g to about 500 mg KOH/g, and a glass transition temperature (T_{g}) of about −70° C. These liquid acrylic oligomers derived from (meth)acrylate monomers typically comprise recurring units of a hydroxyl functional monomer. The hydroxyl functional monomer is used in an amount sufficient to give the acrylic oligomer the desired hydroxyl number and solubility parameter. Typically the hydroxyl functional monomer is used in an amount within the range of about 2% to about 60% by weight (wt %) of the liquid acrylic oligomer. Instead of hydroxyl functional monomers, other polar monomers such as acrylic acid, methacrylic acid, itaconic acid, fumaric acid, acrylamide, methacrylamide, N-alkyl and N,N-dialkyl substituted acrylamide and methacrylamides, N-vinyl lactams, N— vinyl lactones, and the like can also be used to control the solubility parameter of the acrylic oligomer. Combinations of these polar monomers may also be used. The liquid acrylic oligomer derived from acrylate and (meth)acrylate monomers also typically comprises recurring units of one or more C₁ to C₂₀ alkyl(meth)acrylates whose homopolymers have a T_{g} below 25° C. It is important to select a (meth)acrylate that has low homopolymer T_{g} because otherwise the liquid acrylic oligomer can have a high T_{g} and may not stay liquid at room temperature. However, the acrylic oligomer does not always need to be a liquid, provided it can readily be solubilized in the balance of the adhesive blend used in this invention. Examples of suitable commercial (metha)acrylates include n-butyl acrylate, n-butyl methacrylate, lauryl acrylate, lauryl methacrylate, isooctyl acrylate, isononylacrylate, isodecylacrylate, tridecyl acrylate, tridecyl methacrylate, 2-ethylhexyl acrylate, 2-ethylhexyl methacrylate, and mixtures thereof. The proportion of recurring units of C₁ to C₂₀ alkyl acrylates or methacrylates in the acrylic oligomer derived from acrylate and methacrylate monomers depends on many factors, but most important among these are the desired solubility parameter and T_{g} of the resulting adhesive composition. Typically liquid acrylic oligomer derived from acrylate and methacrylate monomers can be derived from about 40% to about 98% alkyl(meth)acrylate monomers.

Optionally, the acrylic oligomer derived from (meth)acrylate monomers can incorporate additional monomers. The additional monomers can be selected from vinyl aromatics, vinyl halides, vinyl ethers, vinyl esters, unsaturated nitriles, conjugated dienes, and mixtures thereof. Incorporation of additional monomers may reduce raw material cost or modify the acrylic oligomer properties. For example, incorporating styrene or vinylacetate into the acrylic oligomer can reduce the cost of the acrylic oligomer.

The liquid acrylic oligomer is typically prepared by a suitable free-radical polymerization process. U.S. Pat. No. 5,475,073 (Guo) describes a process for making hydroxy-functional acrylic resins by using allylic alcohols or alkoxylated allylic alcohols. Generally, the allylic monomer is added into the reactor before the polymerization starts. Usually the (meth)acrylate is gradually fed during the polymerization. Typically, at least about 50% by weight, or at least about 70% by weight, of the (meth)acrylate is gradually added to the reaction mixture. The (meth)acrylate is added at such a rate as to maintain its steady, low concentration in the reaction mixture. The ratio of allylic monomer to (meth)acrylate is kept essentially constant. This helps to produce a acrylic oligomer having a relatively uniform composition. Gradual addition of the (meth)acrylate can enable the preparation of an acrylic oligomer having sufficiently low molecular weight and sufficiently high allylic alcohol or alkoxylated allylic alcohol content. Generally, the free-radical initiator is added to the reactor gradually during the course of the polymerization. Typically the addition rate of the free-radical initiator is matched to the addition rate of the acrylate or methacrylate monomer.

With hydroxyalkyl methacrylate-containing oligomers, a solution polymerization is typically used. The polymerization, as taught in U.S. Pat. Nos. 4,276,212 (Khanna et al.), 4,510,284 (Gempel et al.), and 4,501,868 (Bouboulis et al.), is generally conducted at the reflux temperature of the solvent. The solvents can have a boiling point within the range of about 90° C. to about 180° C. Examples of suitable solvents are xylene, n-butyl acetate, methyl amyl ketone (MAK), and propylene glycol methyl ether acetate (PMAc). Solvent is charged into the reactor and heated to reflux temperature, and thereafter monomer and initiator are gradually added to the reactor.

Suitable liquid acrylic oligomers include copolymers of n-butyl acrylate and allyl monopropoxylate, n-butyl acrylate and allyl alcohol, n-butyl acrylate and hydroxyethyl acrylate, n-butyl acrylate-hydroxylpropyl acrylate, 2-ethylhexyl acrylate and allyl propoxylate, 2-ethylhexyl acrylate and hydroxypropyl acrylate, and the like, and mixtures thereof. Exemplary acrylic oligomer useful in the provided optical assembly are disclosed, for example, in U.S. Pat. Nos. 6,294,607 (Guo et al.) and 7,465,493 (Lu), as well as acrylic oligomer derived from acrylate and methacrylate monomers having the tradename JONCRYL (available from BASF, Mount Olive, N.J.) and ARUFON (available from Toagosei Co., Lt., Tokyo, Japan).

It is also possible to make the provided acrylic oligomers in-situ. For example, if on-web polymerization is used, a monomer composition may be prepolymerized by UV or thermally induced reaction. The reaction can be carried out in the presence of a molecular weight control agent, like a chain-transfer agent or a retarding agent such as, for example, styrene, α-methyl styrene, α-methyl styrene dimer, or to control chain-length and molecular weight of the polymerizing material. When the control agent is consumed, the reaction can proceed with higher molecular weight and true high molecular weight polymer forming Likewise, the polymerization conditions for the first step of the reaction can be chosen in such a way that only oligomerizations happens, followed by a change in polymerization conditions that yields high molecular weight polymer. For example, UV polymerization under high intensity light can result in lower chain-length growth where polymerization under lower light intensity can give higher molecular weight.

The miscible blend also includes a reactive diluent that includes a monofunctional (meth)acrylate monomer. The reactive diluent may comprise more than one monomer, for example, from 2-5 different monomers. Examples of these monomers include alkyl(meth)acrylates where the alkyl group contains 1 to 12 carbons if the alkyl group is linear, and up to 30 carbons if the alkyl group is branched (for example, acrylates derived from Guerbet reactions, or β-alkylated dimer alcohols). Examples of these alkyl acrylate include 2-ethylhexyl(meth)acrylate, isooctyl(meth)acrylate, isononyl(meth)acrylate, isodecyl(meth)acrylate, isotridecyl(meth)acrylate, 2-octyl(meth)acrylate, n-butyl(meth)acrylate, isobutyl(meth)acrylate, and the like. Other (meth)acrylates include isobornyl(meth)acrylate, isobornyl(meth)acrylate, tetrahydrofurfuryl(meth)acrylate, tetrahydrofurfuryl(meth)acrylate, alkoxylated tetrahydrofurfuryl(meth)acrylate, and mixtures thereof. For example, the reactive diluent may comprise tetrahydrofurfuryl(meth)acrylate and isobornyl(meth)acrylate. In another embodiment, the reactive diluent may comprise alkoxylated tetrahydrofurfuryl(meth)acrylate and isobornyl(meth)acrylate.

In general, the reactive diluent may be used in any amount depending on other components used to form the adhesive layer as well as the desired properties of the adhesive layer. The adhesive layer may comprise from about 40 wt % to about 90 wt %, or from about 40 wt % to about 60 wt %, of the reactive diluent, relative to the total weight of the adhesive layer. The particular reactive diluent used, and the amount(s) of monomer(s) used, may depend on a variety of factors. For example, the particular monomer(s) and amount(s) thereof may be selected such that the adhesive composition is a liquid composition having a viscosity of from about 100 to about 1000 cps. For another example, the particular monomer(s) and amount(s) thereof may be selected such that the adhesive composition is a liquid composition having a viscosity of from about 100 to about 1000 cps.

The miscible blend that photo-reacts to form the adhesive layer may further comprise a monofunctional (meth)acrylate monomer having alkylene oxide functionality. This monofunctional (meth)acrylate monomer having alkylene oxide functionality may include more than one monomer. Alkylene functionality includes ethylene glycol and propylene glycol. The glycol functionality is comprised of units, and the monomer may have anywhere from 1 to 10 alkylene oxide units, from 1 to 8 alkylene oxide units, or from 4 to 6 alkylene oxide units. The monofunctional (meth)acrylate monomer having alkylene oxide functionality may comprise propylene glycol monoacrylate available as BISOMER PPA6 from Cognis Ltd., Munich, Germany. This monomer has 6 propylene glycol units. The monofunctional (meth)acrylate monomer having alkylene oxide functionality may comprise ethylene glycol monomethacrylate available as BISOMER MPEG350MA from Cognis Ltd. This monomer has on average 7.5 ethylene glycol units.

Optionally, the miscible photo-reactive blend may also comprise a free-radically copolymerizable, multifunctional (meth)acrylate or vinyl crosslinker. Examples of these crosslinkers include 1,4-butanediol di(meth)acrylate, 1,6 hexanedioldi(meth)acrylate, diethyleneglycol di(meth)acrylate, tetraethyleneglycol di(meth)acrylate, trimethylolpropanetri(meth)acrylate, divinylbenzene, and the like. The low molecular weight crosslinkers are typically used at levels below 1 wt % of the total photo-reactive blend. More commonly, they are used below 0.5 wt % of the total photo-reactive blend. The copolymerizable crosslinkers may also include (meth)acrylate functional oligomers. These oligomers may comprise any one or more of: a multifunctional urethane (meth)acrylate oligomer, a multifunctional polyester (meth)acrylate oligomer, and a multifunctional polyether (meth)acrylate oligomer. The multifunctional (meth)acrylate oligomer may comprise at least two (meth)acrylate groups, e.g., from 2 to 4 (meth)acrylate groups, that participate in polymerization during curing. The adhesive layer may comprise from about 5 wt % to about 60 wt %, or from about 20 wt % to about 45 wt %, of the one or more multifunctional (meth)acrylate oligomer. The particular multifunctional (meth)acrylate oligomer used, as well as the amount used, may depend on a variety of factors. For example, the particular oligomer and/or the amount thereof may be selected such that the adhesive composition is a liquid composition having a viscosity of from about 100 to about 1000 cps. For another example, the particular oligomer and/or the amount thereof may be selected such that the adhesive composition is a liquid composition having a viscosity of from about 100 to about 1000 cps.

The multifunctional (meth)acrylate oligomer may comprise a multifunctional urethane (meth)acrylate oligomer having at least two (meth)acrylate groups, e.g., from 2 to 4 (meth)acrylate groups, that participate in polymerization during curing. In general, these oligomers comprise the reaction product of a polyol with a multifunctional isocyanate, followed by termination with a hydroxy-functional (meth)acrylate. For example, the multifunctional urethane (meth)acrylate oligomer may be formed from an aliphatic polyester or polyether polyol prepared from condensation of a dicarboxylic acid, e.g., adipic acid or maleic acid, and an aliphatic diol, e.g. diethylene glycol or 1,6-hexane diol. In one embodiment, the polyester polyol comprises adipic acid and diethylene glycol. The multifunctional isocyanate may comprise methylene dicyclohexyldiisocyanate or 1,6-hexamethylene diisocyanate. The hydroxy-functional (meth)acrylate may comprise a hydroxyalkyl(meth)acrylate such as 2-hydroxyethyl acrylate, 2-hydroxypropyl(meth)acrylate, or 4-hydroxybutyl acrylate. In one embodiment, the multifunctional urethane (meth)acrylate oligomer comprises the reaction product of a polyester diol, methylene dicyclohexyldiisocyanate, and hydroxyethyl acrylate.

Useful multifunctional urethane (meth)acrylate oligomers include products that are commercially available. For example, the multifunctional aliphatic urethane (meth)acrylate oligomer may comprise urethane diacrylate CN9018, CN3108, and CN3211 available from Sartomer, Co., Exton, Pa., GENOMER 4188/EHA (blend of GENOMER 4188 with 2-ethylhexyl acrylate), GENOMER 4188/M22 (blend of GENOMER 4188 with GENOMER 1122 monomer), GENOMER 4256, and GENOMER 4269/M22 (blend of GENOMER 4269 and GENOMER 1122 monomer) available from Rahn USA Corp., Aurora Ill., and polyether urethane diacrylate BR-3042, BR-3641AA, BR-3741AB, and BR-344 available from Bomar Specialties Co., Torrington, Conn. Additional exemplary multifunctional aliphatic urethane di(meth)acrylates include U-PICA 8967A and U-PICA 8966A urethane diacrylates, available from U-pica, Tokyo, Japan.

The multifunctional (meth)acrylate oligomer may comprise a multifunctional polyester (meth)acrylate oligomer. Useful multifunctional polyester acrylate oligomers include products that are commercially available. For example, the multifunctional polyester acrylate may comprise BE-211 available from Bomar Specialties Co., Torrington, Conn. and CN2255 available from Sartomer Co, Exton, Pa.

The multifunctional (meth)acrylate oligomer may comprise a hydrophobic multifunctional polyether (meth)acrylate oligomer. Useful multifunctional polyether acrylate oligomers include products that are commercially available. For example, the multifunctional polyether acrylate oligomer may comprise GENOMER 3414 available from Rahn USA Corp., Aurora, Ill.

Instead of using multifunctional acrylate or vinyl crosslinkers, it is also possible to utilize chemical crosslinking agents, such as multifunctional isocyanates, peroxides, multifunctional epoxides, multifunctional aziridines, melamines, and the like to introduce limited crosslinking during curing of the photo-reactive blend.

The provided optical display assembly includes a miscible blend that includes a free-radical generating photoinitiator. Free-radical generating photoinitators are well known to those of ordinary skill in the art and include initiators such as IRGACURE 651, available from Ciba Chemicals, Tarrytown, N.Y., which is 2,2-dimethoxy-2-phenylacetophenone. Also useful is DAROCUR 1173, available from BASF, Mount Olive, N.J., which is 2-hydroxy-2-methyl-1-phenyl-propan-1-one or DAROCUR 4265 which is a blend of 50% DAROCUR 1173 and 50% 2,4,6-trimethylbenzoyl-diphenyl-phosphine oxide. Photoinitiators can also include organic peroxides, azo compounds, quinines, nitro compounds, acyl halides, hydrazones, mercapto compounds, pyrylium compounds, imidazoles, chlorotriazines, benzoin, benzoin alkyl ethers, ketones, phenones, and the like. For example, the adhesive compositions may comprise ethyl-2,4,6-trimethylbenzoylphenylphosphinate available as LUCIRIN TPO-L from BASF Corp. or 1-hydroxycyclohexyl phenyl ketone available as IRGACURE 184 from BASF. The photoinitiator is often used at a concentration of about 0.1 part to 10 parts or 0.1 part to 1 part based on 100 parts of acrylic oligomer and (meth)acrylate monomers in the polymerizable composition (miscible blend).

The adhesive layer may comprise a tackifier. Tackifiers are well known and are used to increase the tack or other properties of an adhesive. There are many different types of tackifiers but nearly any tackifier can be classified as: a rosin resin derived from wood rosin, gum rosin or tall oil rosin; a hydrocarbon resin made from a petroleum based feedstock; or a terpene resin derived from terpene feedstocks of wood or certain fruits. The adhesive layer may comprise, e.g., from 0.01 wt % to about 20 wt %, from 0.01 wt % to about 15 wt %, or from 0.01 wt % to about 10 wt % of tackifier. The adhesive layer may be substantially free of tackifier comprising, e.g., from 0.01 wt % to about 5 wt % or from about 0.01 wt % to about 0.5 wt % of tackifier all relative to the total weight of the adhesive layer. The adhesive layer may also be completely free of tackifier.

In general, the adhesive layer may comprise spacer beads in order to “set” a particular thickness of the layer. The spacer beads may comprise ceramic, glass, silicate, polymer, or plastic. The spacer beads are generally spherical and have a diameter of from about 1 μm to about 5 mm, from about 50 μm to about 1 mm, or from about 50 μm to about 0.2 mm. In general, the beads can be colorless and refractive index matched to the cured adhesive layer so they do not interfere with the optics of the cured composition.

In general, the adhesive layer may also comprise non-light absorbing metal oxide particles, for example, to modify the refractive index of the adhesive layer. Non light absorbing metal oxide particles that are substantially transparent may be used. For example, a 1 mm thick disk of the non light absorbing metal oxide particles in an adhesive layer may absorb less than about 15% of the light incident on the disk. Examples of non-light absorbing metal oxide particles include Al₂O₃, ZrO₂, TiO₂, V₂O₅, ZnO, SnO₂, ZnS, SiO₂, and mixtures thereof, as well as other sufficiently transparent non-oxide ceramic materials. The metal oxide particles can be surface treated to improve dispersibility in the adhesive layer and the composition from which the layer is coated. Examples of surface treatment chemistries include silanes, siloxanes, carboxylic acids, phosphonic acids, zirconates, titanates, and the like. Techniques for applying such surface treatment chemistries are known.

Non-light absorbing metal oxide particles may be used in an amount needed to produce the desired effect, for example, in an amount of from about 10 wt % to about 85 wt %, or from about 40 wt % to about 85 wt %, based on the total weight of the adhesive layer. Non-light absorbing metal oxide particles may only be added to the extent that they do not add undesirable color, haze or transmission characteristics. Generally, the particles can have an average particle size of from about 1 nm to about 100 nm.

The liquid compositions and adhesive layers can optionally include one or more additives such as chain transfer agents, antioxidants, stabilizers, fire retardants, viscosity modifying agents, antifoaming agents, antistats, wetting agents, colorants such as dyes and pigments, fluorescent dyes and pigments, or phosphorescent dyes and pigments.

The adhesive layers described above are formed by curing an adhesive composition or liquid composition. Any form of electromagnetic radiation may be used, for example, the liquid compositions may be cured using UV-radiation or visible light. Electron beam radiation may also be used. The liquid compositions described above are said to be cured using actinic radiation, i.e., radiation that leads to the production of photochemical activity. For example, actinic radiation may comprise radiation of from about 250 nm to about 700 nm. Sources of actinic radiation include tungsten halogen lamps, xenon and mercury arc lamps, incandescent lamps, germicidal lamps, fluorescent lamps, lasers and light emitting diodes. UV-radiation can be supplied using a high intensity continuously emitting system such as those available from Fusion UV Systems. If desired, the curing using actinic radiation may be assisted with heat. Alternatively to UV or visible light induced curing, a heat curing mechanism may be used. To heat cure, thermally activated initiators such as peroxides or azo compounds can be used to substitute for the photo-activated initiators in the composition as is well know by those persons having ordinary skill in the art.

In some embodiments, actinic radiation may be applied to a layer of the liquid composition such that the composition is partially polymerized. The liquid composition may be disposed between the display panel and the substantially transparent substrate and then partially polymerized. The liquid composition may be disposed on the display panel or the substantially transparent substrate and partially polymerized, then the other of the display panel and the substrate may be disposed on the partially polymerized layer.

In some embodiments, actinic radiation may be applied to a layer of the liquid composition such that the composition is completely or nearly completely polymerized. The liquid composition may be disposed between the display panel and the substantially transparent substrate and then completely or nearly completely polymerized. The liquid composition may be disposed on the display panel or the substantially transparent substrate and completely or nearly completely polymerized, then the other of the display panel and the substrate may be disposed on the polymerized layer.

In the assembly process, it is generally desirable to have a layer of the liquid composition that is substantially uniform. The two components are held securely in place. If desired, uniform pressure may be applied across the top of the assembly. If desired, the thickness of the layer may be controlled by a gasket, standoffs, shims, and/or spacers used to hold the components at a fixed distance to each other. Masking may be required to protect components from overflow. Trapped pockets of air may be prevented or eliminated by vacuum or other means. Radiation may then be applied to form the adhesive layer.

The optical assembly may be prepared by creating an air gap or cell between the two components and then disposing the liquid composition into the cell. An example of this method is described in U.S. Pat. No. 6,361,389 (Hogue et. al.) and includes adhering together the components at the periphery edges so that a seal along the periphery creates the air gap or cell. Adhering may be carried out using any type of adhesive, e.g., a bond tape such as a double-sided pressure sensitive adhesive tape, a gasket, an RTV seal, etc., as long as the adhesive does not interfere with reworkability as described above. Then, the liquid composition is poured into the cell through an opening at a periphery edge. Alternatively, the liquid composition is injected into the cell maybe using some pressurized injection means such as a syringe. Another opening is required to allow air to escape as the cell is filled. Exhaust means such as vacuum may be used to facilitate the process. Actinic radiation may then be applied as described above to form the adhesive layer.

The optical assembly may be prepared using an assembly fixture such as the one described in U.S. Pat. No. 5,867,241 (Sampica et al.). In this method, a fixture comprising a flat plate with pins pressed into the flat plate is provided. The pins are positioned in a predetermined configuration to produce a pin field which corresponds to the dimensions of the display panel and of the component to be attached to the display panel. The pins are arranged such that when the display panel and the other components are lowered down into the pin field, each of the four corners of the display panel and other components is held in place by the pins. The fixture aids assembly and alignment of the components of an optical assembly with suitable control of alignment tolerances. Additional embodiments of this assembly method are described in Sampica et al. U.S. Pat. No. 6,388,724 (Campbell et. al) describes how standoffs, shims, and/or spacers may be used to hold components at a fixed distance to each other. The optical assembly disclosed herein may comprise additional components typically in the form of layers. For example, a heating source comprising a layer of indium tin oxide or another suitable material may be disposed on one of the components. Additional components are described in, for example, U.S. Pat. Publ. No. 2008/0007675 (Sanelle et al.).

Instead of disposing a miscible blend between the display panel and the substantially transparent substrate to fill the air gap between the display substrates, the optical assembly may be made using a transfer tape comprising a cured adhesive layer. In this process, the liquid adhesive composition of this invention is applied between two siliconized release liners, at least one of which is transparent to the curing radiation wavelength, and then the optical assembly is exposed to light to polymerize or cure the formulation. Typically, the liquid adhesive composition is substantially fully cured. The resulting adhesive composition is now a tacky, fully polymerized optically clear adhesive sheet positioned between two release liners, a so-called transfer tape. In a typical assembly process, one of the release liners of the transfer tape can be removed and the adhesive can be applied to the first substrate of the display assembly using roller applied pressure. Then, the second release liner can be removed and lamination to the second substrate can be completed. If the first substrate is flexible, lamination to a second flexible or rigid substrate can be carried out with simple roller lamination. If both the first and second substrate is rigid, roller lamination can still be used but air bubbles may be trapped between the optically clear adhesive sheet and one or both of the substrates. To minimize the risk for air bubble entrapment, the display assembly industry is also commonly using a vacuum lamination process. In this process, the first substrate covered with the optically clear adhesive sheet is positioned on a holding plate, while the second substrate is positioned on a second holding plate. All the components reside inside a vacuum chamber and during the first step, top and bottom plate are physically separated so the tacky adhesive sheet applied on the first substrate is not in physical contact with the second substrate, but yet it is perfectly aligned. In a second step, vacuum is pulled to eliminate all the air from the chamber and thus from in between the now-to-be laminated display substrates. Once the lowest vacuum pressure is achieved, the top and bottom holding plate are brought together and pressure is applied to plates and the display assembly components to make the final laminate. Finally, the pressure between holding plates and vacuum is released to provide access to the now assembled display panel. If desired, the assembled display panel may be submitted to an autoclave step where both heat and pressure is applied to improve the bond strength of the display and to eliminate any remaining bubbles that are trapped.

The substantially transparent substrate used in the optical assembly may comprise a variety of types and materials. The substantially transparent substrate is suitable for optical applications and typically has at least 85% transmission over the range of from 460 to 720 nm. The substantially transparent substrate may have, per millimeter thickness, a transmission of greater than about 85% at 460 nm, greater than about 90% at 530 nm, and greater than about 90% at 670 nm.

The provided optical assembly may be used in a variety of optical devices including, but not limited to, telephones, televisions, computer monitors, navigation systems, projectors, or active signs. The optical device may also include a backlight.

Objects and advantages of this invention are further illustrated by the following examples, but the particular materials and amounts thereof recited in these examples, as well as other conditions and details, should not be construed to unduly limit this invention.

### EXAMPLES

TABLE 1
Materials
Materials

| Abbreviation or Trade Name | Description |
|---|---|
| U-PICA 8967A | Urethane diacrylate (U-pica, Tokyo, Japan) |
| U-PICA 8966A | Urethane diacrylate (U-pica) |
| SR506A | Isobornyl acrylate (Sartomer Co., Exton, PA) |
| SR335 | Lauryl Acrylate (Sartomer Co.) |
| SR238B | Hexanediol Diacrylate (Sartomer Co.) |
| CD 611 | Alkoxylated tetrahydrofurfuryl acrylate (Sartomer Co.) |
| BISOMER PPA6 | Polypropylene glycol monoacrylate (Cognis Ltd., |
| | Southampton, UK) |
| Soybean oil | Plasticizer (Sigma-Aldrich Chem. Co., St. Louis, MO) |
| JONCRYL 960 | Acrylic oligomer (BASF Corp., Florham Park, NJ) |
| JONCRYL 963 | Acrylic oligomer (BASF Corp.) |
| PINECRYSTAL KE311 | Rosin ester (Arakawa Chemical Ind., Ltd., Osaka, Japan) |
| TPO-L | Ethyl-2,4,6-trimethylbenzoylphenylphosphinate (BASF |
| | Corp.) |
| LUCIRIN TPO | 2,4,6-Trimethylbenzoyl-diphenyl-phosphineoxide, |
| | (BASF Corp.) |
| DAROCUR 4265 | 50% DAROCUR 1173 (2-Hydroxy-2-methyl-1-phenyl- |
| | propan-1-one); and 50% TPO (2,4,6-Trimethylbenzoyl- |
| | diphenyl-phosphineoxide) (BASF Corp.) |
| IRGACURE 184 | 1-Hydroxycyclohexyl phenyl ketone (BASF Corp.) |
| AEROSIL R805 | Fumed silica after treated with an octylsilane, (Evonik |
| | Industries, Parsippany, NJ) |
| SILQUEST A-187 | δ-Glycidoxypropyltrimethoxy Silane, (Momentive |
| | Performance Materials, Albany, NY) |
| 2EHA | 2-Ethylhexyl acrylate |
| IBOA | Isobornyl acrylate (available as SR506A from Sartomer |
| | Co., Exton, PA) |
| HEA | 2-Hydroxyethyl acrylate |
| DAROCUR 1173 | 2-hydroxy-2-methyl-1-phenyl-1-propan-1-one (BASF |
| | Corp., Mount Olive, NJ. |
| IRGACURE 651 | 2,2-dimethoxy-2-phenylacetophenone photoinitiator |
| | (BASF Corp.) |
| HDDA | 1,6-Hexanediol diacrylate (available as SR238B from |
| | Sartomer Co.) |
| KBM-403 | 3-Glycidyloxypropyl)trimethoxysilane (Shin-Etsu |
| | Chemical Co., Ltd., Tokyo, Japan) |

### Preparation of Liquid Optically Clear Adhesives (LOCAs)

### Examples 1-2 and Comparative Examples C1-C4

LOCAs according to Table 2 were prepared, Examples 1 and 2 and Comparative Examples C1 and C2. For a given composition, the LOCA components were charged to a black mixing container, a Max 200 (about 100 cm³), from FlackTek Inc., Landrum, S.C., and mixed using a Hauschild SPEEDMIXER DAC 600 FV, from FlackTek Inc., operating at 2200 rpm for 4 minutes.

The composition of Example 1 was coated at a thickness of 300 microns between 5 mil silicone-coated PET release liners and cured using 21 passes under a Fusion H bulb for a total energy of 9 J/cm2. The release liners were removed and 2.35 g of the cured composition and 7.65 g of methyl ethyl ketone solvent were placed in a glass vial. The cured composition completely dissolved within 45 minutes with intermittent shaking. The results indicate that the cured composition was not crosslinked and that the acrylic oligomer did not participate in any reactions resulting in crosslinking of the cured composition.

TABLE 2
Compositions
(all values in parts by weight)

| | | | Comparative | Comparative | Comparative | Comparative |
|---|---|---|---|---|---|---|
| Component | Example 1 | Example 2 | Example C1 | Example C2 | Example C3 | Example C4 |
| U-PICA 8967A | 11.8 | 11.8 | 39.6 | 36 | 36 | 36 |
| U-PICA 8966A | 8 | 8 | — | 13 | 13 | 13 |
| JONCRYL 963 | 21 | | — | | | |
| JONCRYL 960 | | 21 | | | | |
| SR 335 | 11.6 | 11.6 | — | | | |
| KE-311 | 28.4 | 28.4 | — | | | |
| SR 506A | 17 | 17 | 17 | 33 | 33 | 33 |
| A-187 | 0.2 | 0.2 | — | | | |
| CD 611 | — | — | 21.2 | | | |
| BISOMER PPA6 | — | — | 12.7 | | | |
| Soyabean Oil | — | — | 8.5 | | | |
| BENZOFLEX 988 | | | | 17 | | |
| ADMEX 770 | | | | | 17 | |
| ADMEX 6996 | | | | | | 17 |
| DAROCUR 4265 | 2 | 2 | — | | | |
| TPO-L | — | — | — | 1 | 1 | 1 |
| TPO | — | — | 0.5 | | | |
| IRGACURE 184 | — | — | 0.5 | | | |

### Pressure-sensitive Adhesive (PSA) Preparation

### Examples 3-4 and Comparative Example C5

PSAs according to Table 3 were prepared, Examples 3-4 and Comparative Example C5. For each example and comparative example, a monomer premix was prepared from 2EHA, IBOA, HEA, and DAROCUR 1173. This mixture was partially polymerized under a nitrogen-rich atmosphere by exposure to ultraviolet radiation to provide a syrup having a viscosity of about 1,000 cps. After exposure to UV radiation, the remaining components, as indicated in Table 3, of each example and comparative example were then mixed into the partially polymerized premix. The final compositions were then knife coated in-between two silicone-treated polyethylene terephthalate (PET) release liners at a thickness of 175 mils (4.45 mm). The resulting composite was then exposed to ultraviolet radiation (a total energy of 2,000 mJ/cm²) having a spectral output from 300-400 nm with a maximum at 351 nm.

TABLE 3
PSA Compositions (all values in parts by weight)

| | | | Comparative |
|---|---|---|---|
| Component | Example 3 | Example 4 | Example C5 |
| 2EHA | 55.0 | 55.0 | 55.0 |
| IBOA | 25.0 | 25.0 | 25.0 |
| HEA | 20.0 | 20.0 | 20.0 |
| DAROCUR 1173 | 0.01 | 0.01 | 0.01 |
| JONCRYL 963 | 15.0 | — | — |
| JONCRYL 960 | — | 15.0 | — |
| IRGACURE 651 | 0.29 | 0.29 | 0.29 |
| HDDA | 0.05 | 0.05 | — |
| KBM-403 | 0.05 | 0.05 | 0.05 |
| Storage Modulus | 7.7 × 10⁴ | 7.8 × 10⁴ | 1.1 × 10⁵ |
| G′ at 25 C. (Pa) | | | |
| Tan Delta at 50 C. | 0.72 | 0.51 | 0.33 |
| Transmission of | 91.8% | 91.8% | 91.8% |
| Cured Sample | | | |
| Haze of Cured | 0.1 | 0.1 | 0.1 |
| Sample | | | |
| 50 μm Ink-Wetting | ◯ | Δ | X |
| of Cured Sample | | | |

### Test Methods

### Optical Property Measurements

Optical properties (transmission, haze and color) were measured using an ULTRASCAN PRO spectrophotometer (Hunter Associates Laboratory, Inc., Reston, Va. using standard techniques. The adhesive samples for optical property measurements were prepared as follows. The LOCA was placed between 2″ (5.1 cm)×3″ (7.6 cm) plaques of various bonding substrates (Glass, PMMA, PC and PET). A 10 mil (0.254 mm) thick adhesive tape about 3/16 inch (0.5 cm) wide was placed around the edge of the bottom substrate to create a 10 mil (0.254 mm) thick gap. The LOCA was placed in the gap and the top substrate was placed on top of the LOCA, creating about a 10 mil (0.254 mm) thick LOCA layer. The sample was cured by to UV radiation by passing each through a UV light system, a Model F300S equipped with a type H bulb and a model LC-6 conveyor system all from Fusion UV Systems, Inc, Gaithersburg, Md. for a total UVA dosage of 3000 mJ/cm². For PSA samples the liners were removed, the sample was laminated to a clean microscope slide.

### Rheological Measurements

Viscosity measurements were made using an AR2000 Rheometer equipped with a 40 mm, 1° stainless steel cone and plate from TA Instruments, New Castle, Del. Viscosities were measured using a steady state flow procedure at a frequency of 1 sec⁻¹ with a 28 μm gap between the cone and plate at 25° C. Viscosities are reported at 1 sec⁻¹ and 25° C. Thixotropic index is reported as ratio of viscosity at 0.1 sec⁻¹ and 1 sec¹

### Dynamic Mechanical Analysis (DMA) Measurements

DMA measurements were made on an Ares G2 Rheometer, available from TA

Instruments, New Castle, Del. using parallel plate geometry, 8 mm diameter plates. Samples were die cut from cured film of test material (cured between silicone coated PET release liners). The samples were stacked to a minimum height of 0.5 mm by first removing one liner and applying the test material to the 8 mm plate, then removing the second liner. Subsequent layers were stacked on existing layers that were already on the 8 mm plates. The top 8 mm plate was brought down onto the final stack of material under test and a normal force of 20 grams was applied and maintained with auto tension. The test was run in dynamic oscillation mode at 1 Hz. Auto strain was used to maintain a minimum torque of 500μ/cm² up to 20% strain (the strain was kept within the linear strain regime for the sample). The temperature was ramped from the low setting (−40° C.) to the high setting (75° C.) at a rate of 3 deg C./minute for LOCA adhesives and from −20° C. to 100° C. at a rate of 3 deg C./minute for PSA adhesives

### Shrinkage Measurements

Percent volume shrinkage was measured using an ACCUPYC II 1340 Pycnometer from Micromeritics Instrument Corporation, Norcross, Ga. An uncured LOCA sample of known mass was placed in a silver vial of the Pycnometer. The vial was placed in the Pycnometer and the volume of the sample was measured and the density of the LOCA was determined based on the volume and mass of the sample. Sample mass was about 3.5 grams. The density of a cured LOCA sample was measured following the same procedure as that of the uncured. Cured LOCA samples were prepared in a mold as follows. The mold comprised three components; a glass base, a PET release liner and a polytetrafluoroethylene plate with a cavity. The cavity size was 3.27 mm thickness by 13.07 mm in diameter. The three elements of the mold; glass base, release liner and polytetrafluoroethylene plate were clamped together prior to filling with LOCA. The filled mold was exposed to UV radiation by passing each through a UV light system, a Model F300S equipped with a type H bulb and a Model LC-6 conveyor system all from Fusion UV Systems, Inc, Gaithersburg, Md. The molds were run through the system 5 times at as speed of 4″/sec (10 cm/sec). The molds were then turned over and run an additional 5 times at as speed of 4″/sec (10 cm/sec) through the light system, exposing the partially cured LOCA though the glass plate, to ensure complete cure of the LOCAs. The total UVA energy each side received was about 2,500 mJ/cm², as measured by UV POWER PUCK II available from EIT, Inc. Sterling, Va. Volume shrinkage was then calculated from the following equation:

{[(1/Avg Liquid Density)−(1/Avg Cured Density)]/(1/Avg Liquid Density)}×100%

### Adhesion Measurements

Adhesion measurements were made using a modified ASTM D 1062-02 tensile test method. LOCA was placed between standard 1″ (2.5 cm)×3″ (7.6 cm) glass microscope slides with an overlapping area of 1 in² (6.4 cm²). An adhesive thickness of 10 mils (0.254 mm) was obtained by using 10 mil (0.254 mm) thick adhesive tape as spacer between the glass slides. The LOCA was cured for 10 seconds (ca. 3000 mJ/cm² UVA energy) with an OMNICURE S2000 UV/Visible Spot Curing System having a high pressure 200 watt mercury vapor UV lamp available from EXFO Photonic Solutions, Inc., Mississauga, Ontario. Tensile force was measured using an MTS Insight 30 EL Electromechanical Testing System (MTS Systems Corp., Eden Prairie, Minn.) at 2 inches/min (5 cm/min) at 72° F. (22.2° C.). Results are reported as Max Peel force (N/cm²) and Total Energy (kg-mm) Failure mode is reported as either adhesive or cohesive.

### Ink Wetting Capability

This test was carried out for the fully cured PSA samples shown in Table 3 and measures the ability of the adhesive to wet out ink and resist the formation of new bubbles after being deformed at the large ink step. The PSA sample was laminated between a plain rectangular (19 cm×12 cm) glass panel and a rectangular (19 cm×12 cm) glass panel with a black ink (50 μm height×0.6 cm width) along the four edges using a vacuum laminator (13N/cm2 pressure for 15 sec, 30 Pa vacuum). The laminate was then autoclaved (40° C., 0.4 MPa pressure for 30 min) and subsequently inspected for bubbles that form in the adhesive near the ink edge where they would interfere with the viewing area of the display. The symbols mean the following: O means there are minimum bubbles (<5) around the ink, Δ means there are a few bubbles (<10) around the ink, and X means there are significant bubbles (>10) around the ink.

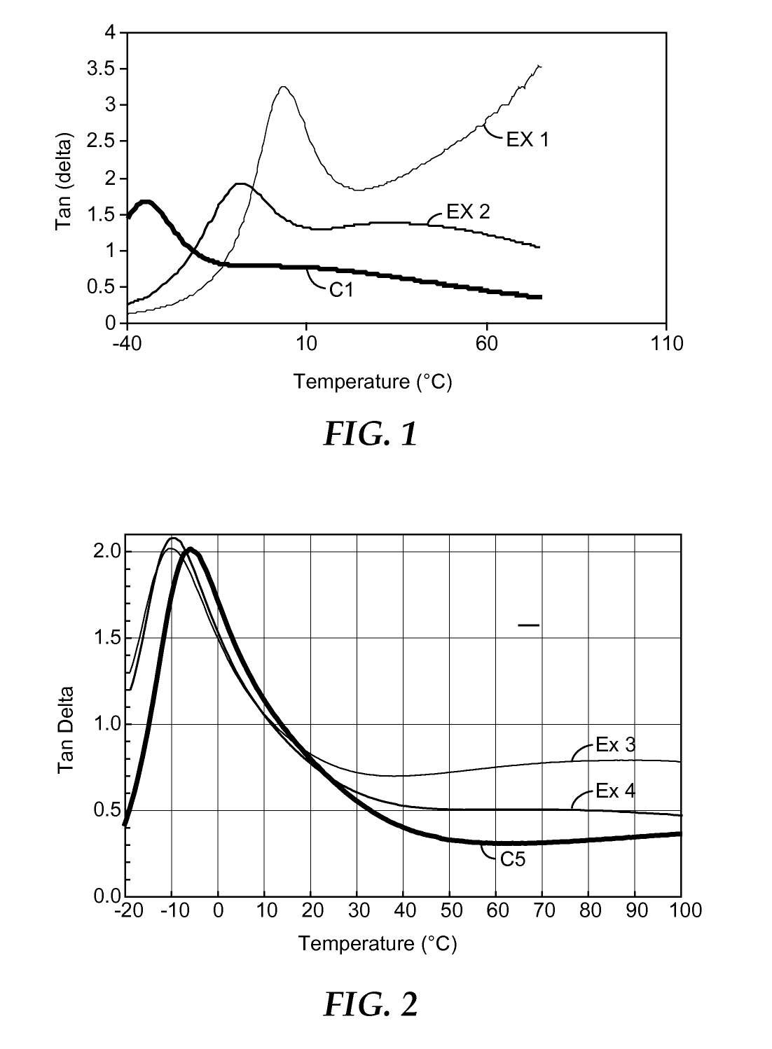

Adhesion to glass, shrinkage and modulus data for Examples 1 and 2 and Comparative Examples C1 to C4 are shown in Table 4 while DMA data for Example 1 and Comparative Example C1 are shown in FIG. 1.

TABLE 4
Properties of Examples 1-2 and Comparative Examples C1-C4

| | | Optical | | | |
|---|---|---|---|---|---|
| | | Clarity | Adhesion | Modulus | % |
| | | after | to glass | (G′ at | Shrink- |
| Material | Additive | cure | (N/cm2) | 25 C.) | age |
| C1 | Soyabean oil | ✓ | 30 | 1.20E+05 | 3.4 |
| C2 | ADMEX 770 | X | NA | NA | NA |
| C3 | BENZOFLEX 9-88 | X | NA | NA | NA |
| C4 | ADMEX 6996 | X | NA | NA | NA |
| Ex. 1 | JONCRYL 963 | ✓ | 80 | 1.50E+04 | 2.6 |
| Ex. 2 | JONCRYL 960 | ✓ | 74 | NA | 2.56 |

The stress from optically clear adhesives plays a crucial role in durability displays. The stress induced by the adhesive at different stages of display construction and reliability testing can be summarized as:

$$Stress α \frac{Adhesion}{Shrinkage * Modulus * ( C T E mismatch with bond substrates )}$$

In display bonding, when the adhesive is applied in liquid-form (LOCA), the shrinkage during UV curing plays a significant role in display performance. The sudden decrease in adhesive volume from un-cured to cured state can cause distortion of the LCD, resulting in uneven screen image uniformity. Also, additional stresses are generated during different types of reliability testing that can increase deformation of LCD resulting in non-uniform optical performance (Mura), adhesive delamination from one or both the bond substrates, and/or bubble/void formation.

Lower shrinkage coupled with lower modulus, matched thermal expansion with bond substrates, and high adhesion are ideal for good display bonding. However, it is difficult to develop an adhesive, which offers a combination of all these properties. The provided optical assemblies include adhesive compositions that offer optimum combinations of low-stress characteristics while retaining high adhesion and tensile properties.

The additives evaluated such as the plasticizers in examples C2-C4 were not compatible with rest of adhesive components resulting in hazy appearance after cure. Both the soybean oil (C1) and the acrylic oligomers (Ex. 1 and Ex. 2) resulted in clear films after cure, indicating good compatibility with other adhesive components, but soybean oil (C1) causes a significant reduction in adhesion values compared to examples containing acrylic oligomers (Ex. 1 and Ex. 2). In summary, adhesive compositions containing acrylic oligomers (Ex. 1 and Ex. 2) offer balanced low stress (due to combination of low modulus and low shrinkage) and good adhesion properties required for a durable display.

DMA data for Examples 3, 4, and Comparative Example 5 are shown in FIG. 2. The DMA measurements, generally, show a higher tan δ value (>0.4) for Examples 3 and 4 compared to Comparative Example C5, particularly at temperatures greater than about 25° C. Higher tan δ values are characteristic of adhesives that have better adhesive flow (good for ink-wetting) and better stress relaxation. The examples show that adhesives with high tan δ values and improved ink wetting can be obtained by incorporating an acrylic oligomer in the adhesive.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

Following are exemplary embodiments of the provided optical assemblies including stress-relieving optical adhesives and methods of making the same.

Embodiment 1 is an optical assembly comprising: a display panel; a substantially transparent substrate; and an adhesive layer disposed between the display panel and the substantially transparent substrate, the adhesive layer comprising the reaction product of a miscible blend comprising: an acrylic oligomer; a reactive diluent comprising a monofunctional (meth)acrylate monomer; and a free-radical generating initiator, wherein the acrylic oligomer comprises an acrylic oligomer derived from (meth)acrylate monomers.

Embodiment 2 is an optical display assembly according to embodiment 1, wherein the reaction product of the miscible blend comprises a photo-reaction product.

Embodiment 3 is an optical display assembly according to embodiment 1, wherein the free-radical generating initiator comprises a photoinitiator.

Embodiment 4 is an optical display assembly according to embodiment 1, wherein the miscible blend comprises: a) from about 60 parts to about 5 parts of a mixture of one or more acrylic oligomers; b) from about 40 parts to about 95 parts of a mixture of one or more monofunctional (meth)acrylate monomers c) from about 0.01 parts to about 1.0 part of one or more free-radical generating initiators based upon 100 parts of components a) and b).

Embodiment 5 is the optical assembly according to embodiment 1 further comprising a multifunctional acrylate or vinyl crosslinker

Embodiment 6 is the optical assembly according to embodiment 1, further comprising a tackifier.

Embodiment 7 is an optical assembly according to embodiment 1, wherein the adhesive layer further comprises a plasticizer, a filler, an adhesion promoter, a stabilizer, a pigment, or a combination thereof.

Embodiment 8 is the optical assembly according to embodiment 4, wherein the mixture of one or more acrylic oligomers comprises an acrylic polyol.

Embodiment 9 is an optical assembly according to embodiment 4, wherein the mixture of one or more (meth)acrylate monomers comprises at least one alkyl(meth)acrylate ester.

Embodiment 10 is an optical assembly according to embodiment 9, wherein the at least one alkyl(meth)acrylate ester is selected from 2-ethylhexyl(meth)acrylate, isooctyl(meth)acrylate, isobornyl(meth)acrylate, butyl(meth)acrylate, methyl(meth)acrylate, laurylacrylate, 2-hydroxyethyl(meth)acrylate, and combinations thereof.

Embodiment 11 is an optical assembly according to embodiment 1, wherein the display panel is selected from a liquid crystal display, a plasma display, a light-emitting diode (LED) display, an electrophoretic display, and a cathode ray tube display.

Embodiment 12 is an optical assembly according to embodiment 11, wherein the display panel is touch-sensitive.

Embodiment 13 is an optical assembly according to embodiment 1, wherein the substantially transparent substrate is selected from a reflector, a polarizer, a mirror, an anti-glare or anti-reflective film, an anti-splinter film, a diffuser, or an electromagnetic interference filter.

Embodiment 14 is an optical assembly according to embodiment 4, wherein the one or more acrylic oligomers have a weight average molecular weight of greater than 1000 and not exceeding entanglement molecular weight Mₑ.

Embodiment 15 is an optical assembly according to embodiment 3, wherein the adhesive composition has been cured by exposure to actinic radiation at a wavelength at least partially absorbed by the photoinitiator, and wherein the acrylic oligomer is not substantially crosslinked into the cured composition.

Embodiment 16 is a method of making an optical assembly comprising: providing a display panel and a substantially transparent substrate; disposing miscible blend of photo-reactive adhesive components on the display panel; contacting the substrate with the adhesive components so as to form an optically clear laminate of the display panel, adhesive components and substrate; and exposing the optical assembly to energy at least partially absorbed by the initiator, wherein the miscible blend comprises: an acrylic oligomer; a reactive diluent comprising a monofunctional (meth)acrylate monomer; and a free-radical generating initiator, wherein the acrylic oligomer comprises a substantially acrylic oligomer derived from acrylate and methacrylate monomers.

Embodiment 17 is a method of making an optical assembly according to embodiment 16, wherein the initiator comprises a photoinitiator and the energy comprises actinic radiation.

Embodiment 18 is a method of making an optical assembly according to embodiment 16, wherein the miscible blend comprises: a) from about 60 parts to about 5 parts of a mixture of one or more acrylic oligomers; b) from about 40 parts to about 95 parts of a mixture of one or more monofunctional (meth)acrylate monomers; and c) from about 0.01 parts to about 1.0 part of one or more free-radical generating initiators based upon 100 parts of components a) and b).

Embodiment 19 is a method of making an optical assembly according to embodiment 16, further comprising a multifunctional acrylate or vinyl crosslinker.

Embodiment 20 is a method of making an optical assembly according to embodiment 16, wherein the display panel is selected from a liquid crystal display, a light-emitting diode display, an electrophoretic display, and a cathode ray tube display.

Embodiment 21 is a method of making an optical assembly according to embodiment 20, wherein the substantially transparent substrate is touch-sensitive.

Embodiment 22 is a method of making an optical assembly according to embodiment 16, wherein the substantially transparent substrate is selected from a reflector, a polarizer, a mirror, an anti-glare or anti-reflective film, an anti-splinter film, a diffuser, or an electromagnetic interference filter.

Embodiment 23 is a method of making an optical assembly comprising: providing a display panel and a substantially transparent substrate; laminating a cured adhesive layer between the substantially transparent substrate and the display panel, wherein the adhesive layer comprises the reaction product of a miscible blend comprising: an acrylic oligomer;

a reactive diluent comprising a monofunctional (meth)acrylate monomer; and a free-radical generating initiator, wherein the acrylic oligomer comprises an acrylic oligomer derived from (meth)acrylate monomers.

Embodiment 24 is a method of making an optical assembly according to embodiment 23, wherein reaction-product comprises a photo-reaction product and the initiator comprises a photoinitiator.

Embodiment 25 is a method of making an optical assembly according to embodiment 24, wherein the cured adhesive layer is prepared by a method comprising: disposing the miscible blend between two release liners, at least one release liner being substantially transparent to UV radiation; and exposing the miscible blend to actinic radiation at a wavelength at least partially absorbed by the photoinitiator to make the cured adhesive layer.

Embodiment 26 is an adhesive article comprising: a backing material; and a pressure-sensitive adhesive composition disposed upon the backing material, wherein the pressure-sensitive adhesive composition comprising the reaction product of a miscible blend comprising: a) from about 60 parts to about 5 parts of a mixture of one or more acrylic oligomers; b) from about 40 parts to about 95 parts of a mixture of one or more monofunctional (meth)acrylate monomers; and c) from about 0.01 parts to about 1.0 part of one or more free-radical generating initiators based upon 100 parts of components a) and b), wherein the acrylic oligomer derived from acrylate and methacrylate monomers is not substantially bonded to the cured composition.

The foregoing description of the preferred embodiment of the provided optical assemblies and methods of making the same has been presented for purposes of illustration and description. It is not intended to be exhaustive or to limit the invention to the precise forms disclosed, since many modifications or variations thereof are possible in light of the above teaching. All such modifications and variations are within the scope of the invention. The embodiments described herein were chosen and described in order to best explain the principles of the invention and its practical application, thereby to enable others skilled in the art to utilize the invention in various embodiments and with various modifications as are suited to the particular use contemplated thereof. It is intended that the scope of the invention be defined by the claims appended hereto, when interpreted in accordance with the full breadth to which they are legally and equitably suited.

1. An optical assembly comprising:
a display panel;
a substantially transparent substrate; and
an adhesive layer disposed between the display panel and the substantially transparent substrate, the adhesive layer comprising the reaction product of a miscible blend comprising:
an acrylic oligomer;
a reactive diluent comprising a monofunctional (meth)acrylate monomer; and
a free-radical generating initiator,
wherein the acrylic oligomer comprises an acrylic oligomer derived from (meth)acrylate monomers.

2. An optical display assembly according to claim 1, wherein the reaction product of the miscible blend comprises a photo-reaction product.

3. (canceled)

4. An optical display assembly according to claim 1, wherein the miscible blend comprises:
a) from about 60 parts to about 5 parts of a mixture of one or more acrylic oligomers;
b) from about 40 parts to about 95 parts of a mixture of one or more monofunctional (meth)acrylate monomers; and
c) from about 0.01 parts to about 1.0 part of one or more free-radical generating initiators based upon 100 parts of components a) and b).

5. The optical assembly according to claim 1 further comprising a multifunctional acrylate or vinyl crosslinker.

6-7. (canceled)

8. The optical assembly according to claim 4, wherein the mixture of one or more acrylic oligomers comprises an acrylic polyol.

9. An optical assembly according to claim 4, wherein the mixture of one or more (meth)acrylate monomers comprises at least one alkyl(meth)acrylate ester.

10. (canceled)

11. An optical assembly according to claim 1, wherein the display panel is selected from a liquid crystal display, a plasma display, a light-emitting diode (LED) display, an electrophoretic display, and a cathode ray tube display.

12. (canceled)

13. An optical assembly according to claim 1, wherein the substantially transparent substrate is selected from a reflector, a polarizer, a mirror, an anti-glare or anti-reflective film, an anti-splinter film, a diffuser, or an electromagnetic interference filter.

14. An optical assembly according to claim 4, wherein the one or more acrylic oligomers have a weight average molecular weight of greater than 1000 and not exceeding entanglement molecular weight Mₑ.

15. An optical assembly according to claim 1, wherein the adhesive composition has been cured by exposure to actinic radiation at a wavelength at least partially absorbed by the free-radical generating initiator, and wherein the acrylic oligomer is not substantially crosslinked into the cured composition.

16. A method of making an optical assembly comprising:
providing a display panel and a substantially transparent substrate;
disposing miscible blend of photo-reactive adhesive components on the display panel;
contacting the substrate with the adhesive components so as to form an optically clear laminate of the display panel, adhesive components and substrate; and
exposing the optical assembly to energy at least partially absorbed by the initiator, wherein the miscible blend comprises:
an acrylic oligomer;
a reactive diluent comprising a monofunctional (meth)acrylate monomer; and
a free-radical generating initiator,
wherein the acrylic oligomer comprises a substantially acrylic oligomer derived from acrylate and methacrylate monomers.

17. (canceled)

18. A method of making an optical assembly according to claim 16, wherein the miscible blend comprises:
a) from about 60 parts to about 5 parts of a mixture of one or more acrylic oligomers;
b) from about 40 parts to about 95 parts of a mixture of one or more monofunctional (meth)acrylate monomers; and
c) from about 0.01 parts to about 1.0 part of one or more free-radical generating initiators based upon 100 parts of components a) and b).

19. A method of making an optical assembly according to claim 16, further comprising a multifunctional acrylate or vinyl crosslinker.

20. A method of making an optical assembly according to claim 16, wherein the display panel is selected from a liquid crystal display, a light-emitting diode display, an electrophoretic display, and a cathode ray tube display.

21. A method of making an optical assembly according to claim 20, wherein the substantially transparent substrate is touch-sensitive.

22. A method of making an optical assembly according to claim 16, wherein the substantially transparent substrate is selected from a reflector, a polarizer, a mirror, an anti-glare or anti-reflective film, an anti-splinter film, a diffuser, or an electromagnetic interference filter.

23. A method of making an optical assembly comprising:
providing a display panel and a substantially transparent substrate; and
laminating a cured adhesive layer between the substantially transparent substrate and the display panel,
wherein the adhesive layer comprises the reaction product of a miscible blend comprising:
an acrylic oligomer;
a reactive diluent comprising a monofunctional (meth)acrylate monomer; and
a free-radical generating initiator,
wherein the acrylic oligomer comprises an acrylic oligomer derived from (meth)acrylate monomers.

24. A method of making an optical assembly according to claim 23, wherein reaction-product comprises a photo-reaction product and the initiator comprises a photoinitiator.

25. A method of making an optical assembly according to claim 24, wherein the cured adhesive layer is prepared by
a method comprising:
disposing the miscible blend between two release liners, at least one release liner being substantially transparent to UV radiation; and
exposing the miscible blend to actinic radiation at a wavelength at least partially absorbed by the photoinitiator to make the cured adhesive layer.

26. An adhesive article comprising:
a backing material; and
a pressure-sensitive adhesive composition disposed upon the backing material, wherein the pressure-sensitive adhesive composition comprising the reaction product of a miscible blend comprising:
a) from about 60 parts to about 5 parts of a mixture of one or more acrylic oligomers;
b) from about 40 parts to about 95 parts of a mixture of one or more monofunctional (meth)acrylate monomers; and
c) from about 0.01 parts to about 1.0 part of one or more free-radical generating initiators based upon 100 parts of components a) and b), wherein the acrylic oligomer derived from acrylate and methacrylate monomers is not substantially bonded to the cured composition.
